(19) United States
(12) Patent Application Publication
(10) Pub. No.: US 2010/0121489 A1
(43) Pub. Date: May 13, 2010

(54) ROBOT AND ROBOT SYSTEM

(75) Inventors: Mitsuhiro INAZUMI, Shiojiri (JP); Takashi NAGATE, Shimosuwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/613,624

(22) Filed: Nov. 6, 2009

(30) Foreign Application Priority Data
Nov. 11, 2008 (JP) 2008-288533

(51) Int. Cl. G05B 19/00; G06F 19/00

(52) U.S. Cl. 700/255; 700/245

(57) ABSTRACT

A robot system includes a robot including a movable portion, a plurality of transmitters that is provided on the movable portion and transmits wireless signals, three or more receivers receiving the wireless signals transmitted from each of the transmitters, and a position calculating unit detecting locations of the transmitters based on the wireless signals that the plurality of the receivers receives. In the system, the position calculating unit detects a pose of the robot from information on the locations of the detected plurality of the transmitters.

### BACKGROUND

1. Technical Field

The present invention relates to a robot, a robot system, and the like. The invention especially relates to position detection of a movable portion of the robot.

2. Related Art

Manufacturing apparatuses using a plurality of robots are widely used to automate tasks. In general, the robots are programmed so as to operate in synchronization with an operation of each robot. Thus, the robots do not collide with each other. In a case where each robot is autonomously operated, it potentially results in a collision with each other. A method for preventing the collision between the robots is disclosed in JP-A-2004-280635. In the method, the collision is prevented by simulating operations of each robot. According to the method, a plurality of models of the robot is formed in a computer so as to presume a transition of major points forming the models. Subsequently, it is examined that whether or not the robot models interfere with each other. In a case where the robot models interfere with each other, one of the robots is stopped for a predetermined time in order to avoid a collision.

A method for detecting a location to which a mobile robot moves is disclosed in JP-A-2007-300470. According to the method, the robot moves with a radio frequency identification (RFID) tag or an ultrasonic wave tag. A position of the robot is detected by a reception of a radio wave or an ultrasonic wave at a receiver.

In simulating operations of the robot, it is necessary to recognize positions of movable portions, such as arms and hands, included in the robot. Thus, a robot is required that can detect the positions of the movable portions in a short period of time.

### SUMMARY

The invention intends to solve at least part of the above problem, and can be realized by the following aspects.

According to a first aspect of the invention, a robot system includes a robot including a movable portion, a plurality of transmitters that is provided on the movable portion and transmits wireless signals, three or more receivers receiving the wireless signals transmitted from each of the transmitters, and a position calculating unit detecting locations of the transmitters based on the wireless signals that the plurality of the receivers receives. In the system, the position calculating unit detects a pose of the robot from information on the locations of the detected plurality of the transmitters.

According to the robot system, the wireless signal transmitted from the transmitter is received by the three or more of the receivers. The longer a distance between the transmitter and the receiver, the longer it takes for the receiver to receive the wireless signal. The distance between the transmitter and the receiver can be calculated by multiplying a propagation velocity of the wireless signal by time required for the propagation. Thereafter, a relative position between the transmitter and the receiver can be calculated by a triangulation method.

The transmitters are provided on the movable portion of the robot. Thus, by detecting locations of the transmitters, a pose of the robot can be detected. The pose of the robot is detected by providing a sensor, such as an encoder, to a portion where the movable portions are coupled to each other. Then, a relative position between the movable portions is detected. In that case, positional data of one end of each movable portion and positional data of another end of each movable portion are detected, so that it is possible to recognize a relative position of both ends of the movable portion to be coupled. In a case where the robot includes a plurality of the movable portions, a location of the movable portion at a terminal is recognized by adding information on relative positions of each movable portion. With the method according to the first aspect, locations of the transmitters can be directly detected. Therefore, the position calculating unit can detect a position and a pose of the movable portion in a short period time compare with the method in which the position and the pose of the movable portion are calculated by the relative positions between each movable portion.

The robot system may further include a conveyor conveying a workpiece and a plurality of transmitters provided on the conveyor. In the system, the position calculating unit may detect a location of the conveyor with the receivers so as to calculate a relative position between the conveyor and the robot.

According to the robot system, the position calculating unit calculates a relative position between the conveyor device and the robot. As a result, the robot can recognize a reachable range of the movable portions of the robot with respect to the conveyor device.

In the robot system, the position calculating unit may calculate a trajectory of the movable portion.

According to the robot system, the position calculating unit can presume inertia force applied to each movable portion using the computed trajectory of the movable portion.

In the robot system, the transmitter is an ultrasonic wave tag transmitting an ultrasonic wave while each of the receivers receives the ultrasonic wave.

According to the robot system, the distance between the transmitter and the receiver is measured using the ultrasonic waves. Compared with a propagation velocity of electromagnetic waves such as light and radio waves, a propagation velocity of the ultrasonic waves is slower. Therefore, the ultrasonic waves have a longer propagation time than the electromagnetic waves. As a result, arrival time of the ultrasonic waves can be easily measured compared with the case of using the electromagnetic waves.

In the robot system, the number of transmitters provided on the movable portion may be equal to or larger than the number of degrees of freedom at the movable portion.

According to the robot system, a location to which the movable portion moves can be detected corresponding to the number of degrees of freedom at the movable portion.

The robot system may further include a simulation calculating unit calculating a transition of the trajectory of the movement of the movable portion. In the system, the simulation calculating unit may calculate the transition of the trajectory of the movement using the locational information on the transmitters.

According to the robot system, a pose of the movable portion can be recognized from the locational information on the transmitter. Then, the transition of the movable portion is calculated from the pose. The transition of the movable portion is computed based on the position of the movable portion before the transition. As a result, the transition of the movable portion can be accurately computed.

According to a second aspect of the invention, a robot system includes a plurality of robots operating in the robot system, a plurality of transmitters that is provided on a movable portion of each of the robots and transmits wireless signals, three or more receivers receiving the wireless signals transmitted from each of the transmitters, a position calculating unit detecting locations of the transmitters based on the wireless signals that the plurality of the receivers receives, and a collision calculating unit presuming whether or not the robots collide with each other. In the system, the collision calculating unit detects a collision between the robots using information on the locations of the transmitters.

According to the robot system, the locations of the transmitters can be detected in a short period of time. The collision calculating unit detects a collision between the robots using the locational information on the transmitters. As a result, the collision between the robots can be detected in a short period of time.

In the robot system, the transmitter may be an ultrasonic wave tag transmitting an ultrasonic wave while each of the receivers may receive the ultrasonic wave.

According to the robot system, the distance between the transmitter and the receiver is measured using the ultrasonic waves. Compared with a propagation velocity of electromagnetic waves such as light and radio waves, a propagation velocity of the ultrasonic waves is slower. Therefore, the ultrasonic waves have a longer propagation time than the electromagnetic waves. As a result, arrival time of the ultrasonic waves can be easily measured compared with the electromagnetic waves.

In the robot system, the collision calculating unit may include a simulation calculating unit calculating a transition of a trajectory of a movement of the movable portion and an interference calculating unit calculating whether or not the movable portion of each of the robot interfere with each other.

According to the robot system, the simulation calculating unit calculates the transition of the movable portion. Then, the collision calculating unit calculates whether or not the movable portions collide with each other. As a result, it is possible to detect a collision between the movable portions at each location during the movement of the movable portions.

### BRIEF DESCRIPTION OF THE DRAWINGS

The invention will be described with reference to the accompanying drawings, wherein like numbers reference like elements.

FIG. 1 is a perspective view schematically showing a structure of a robot system.

FIG. 2 is a perspective view schematically showing a robot.

FIG. 3A is a sectional view schematically showing a robot ultrasonic wave tag while FIG. 3B is a block diagram showing an electric control of the ultrasonic wave tag.

FIG. 4 is a block diagram showing an electric control of the robot system.

FIG. 5 is a flowchart showing a process of moving a workpiece to storage.

FIGS. 6A, 6B, 6C, and 6D are diagrams showing an operation method using the robot.

FIGS. 7A and 7B are diagrams showing the operation method using the robot.

FIGS. 8A and 8B are diagrams showing the operation method using the robot.

FIGS. 9A, 9B, and 9C are diagrams showing the operation method using the robot.

FIGS. 10A, 10B, and 10CB are diagrams showing the operation method using the robot.

### DESCRIPTION OF EXEMPLARY EMBODIMENT

Hereinafter, an embodiment of the invention will be described with reference to the accompanying drawings. The scales of members in the drawing are adequately changed so that they can be recognized.

### Embodiment

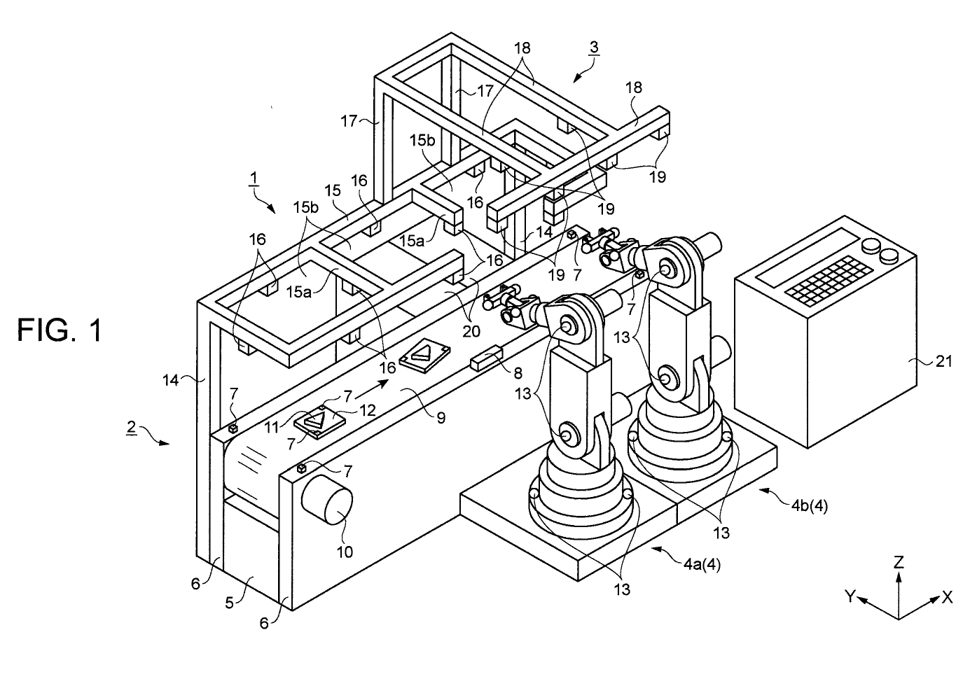

A robot, a robot system, and a method for controlling the robot according to the embodiment will be described with reference to FIGS. 1 to 10C. The method for controlling the robot will be described using an example. In the example, two robots move while respectively gripping a workpiece. The robots release the workpiece, so that the workpiece is moved.

FIG. 1 is a perspective view schematically showing a structure of the robot system. As shown in FIG. 1, a robot system 1 mainly includes a conveyor device 2 serving as a conveyer, a position detecting unit 3, and a robot 4. The conveyor device 2 includes a base 5 formed long in one direction. A longitudinal direction of the base 5 is referred to as an X direction. A direction opposite to the gravity direction is referred to as a Z direction while a direction orthogonal to the X and Y directions is referred to as a Y direction.

Provided on both sides of the base 5 in the Y direction is a pair of side plates 6. Provided on both ends in the X direction of upper surfaces of each side plate 6 are workpiece ultrasonic wave tags 7 serving as a transmitter and an ultrasonic wave tag. Further, provided on the upper surface of the side plate 6, which is a side adjacent to the robot 4, is a radio wave transmitting device 8. Each of the workpiece ultrasonic wave tags 7 includes an ultrasonic wave generating source inside thereof, being able to transmit ultrasonic waves serving as a wireless signal. Locations of the workpiece ultrasonic wave tags 7 installed on each side plate 6 are detected so that positions of the side plates 6 can be recognized. The radio wave transmitting device 8 includes a transmission circuit and an antenna, being able to transmit radio signals having a predetermined waveform.

Provided between the two side plates 6 is a belt 9. The belt 9 is a sheet formed in a cylindrical shape and includes a pulley inside thereof (not shown). A predetermined tension is applied to the belt 9 in the X direction by the pulley. A motor 10 is provided on a surface of the side surface 6, which is adjacent to the robot 4, in the left when viewed from the robot 4. A drive shaft of the motor 10 is coupled to the pulley. Placed on the upper surface of the belt 9 are workpieces 11, and each of the workpieces 11 is supported by a workpiece support 12. A plurality of the workpiece ultrasonic wave tags 7 is provided on the workpiece support 12. The workpiece 11 is placed on the belt 9 by a supply device that is not shown. It is possible to move the workpiece 11 in the X direction via the belt 9 by driving the motor 10.

A relative positional relation between the side plates 6 and the belt 9 is set in advance. The robot system 1 can recognize a location of the belt 9 by detecting locations of the workpiece ultrasonic wave tags 7 provided on the side plates 6. Accordingly, the robot system 1 can recognize a flow direction of the workpiece 11 as well as a movable range of the workpiece 11.

Two of the robots 4 are provided in the right when the conveyor device 2 is viewed in the X direction and in the right when the conveyor device 2 is viewed in the Y direction. The robot 4 positioned on a side opposite to the X direction is referred to as a first robot 4a. The robot 4 positioned on a side in the X direction is referred to as a second robot 4b. The robot 4 is provided nearby the belt 9, being able to grip the workpiece 11 on the belt 9. Provided on the robot 4 is a plurality of robot ultrasonic wave tags 13 serving as a transmitter and a ultrasonic wave tag.

Two first struts 14 are vertically arranged in the Z direction at a side surface in the Y direction with respect to the conveyor device 2. Provided on the first struts 14 is a first receiving device support 15. The outline of the first receiving device support 14 is an almost rectangular shape by braces. The first receiving device support 15 includes two braces 15a provided inside thereof, so that the first receiving device support 15 includes three rectangular windows 15b formed therein. Provided to the braces corresponding to each side of the three windows 15b are workpiece ultrasonic wave receiving devices 16. Each of the workpiece ultrasonic wave receiving devices 16 receives ultrasonic wave signals. The workpiece ultrasonic wave receiving device 16 is provided so as to oppose the conveyor device 2. The workpiece ultrasonic wave receiving device 16 is placed above the belt 9, being able to receive ultrasonic wave signals transmitted from the workpiece ultrasonic wave tag 7. The workpiece ultrasonic wave receiving devices 16 are arranged in a predetermined layout. Accordingly, three or more of the workpiece ultrasonic waver receivers 16 receive the ultrasonic wave signals transmitted from the single workpiece ultrasonic wave tag 7.

Two second struts 17 are arranged vertically on the first receiving device support 15. Provided on the second struts 17 are second receiving device supports 18. The second receiving device supports 18 are provided so as to extend in the direction opposite to the Y direction. Thus, the second receiving device supports 18 reach above the robot 4. The second receiving device supports 18 are cross-linked to each other in the X direction above the robot 4. Provided to the second receiving device supports 18 are robot ultrasonic wave receiving devices 19, serving as a receiver, so as to oppose the robot 4. Three robot ultrasonic wave receiving devices 19 are provided above each robot 4. Each of the ultrasonic wave receiving devices 19 can receive ultrasonic wave signals transmitted from the robot ultrasonic wave tag 13.

Provided in the Y direction with respect to the conveyor device 2 is as a storage device 20. By changing a pose, the robot 4 can move the workpiece 11 placed on the belt 9 to above the storage device 20. The storage device 20 includes a lifting mechanism therein, lowering the upper surface thereof in accordance with the amount of the workpiece 11. The storage device 20 moves an area to which the workpiece 11 to be placed to the same level as the belt 9.

Provided in the X direction with respect to the robot 4 is a control device 21. The control device 21 controls the robot system 1 including the conveyor device 2, the position detecting unit 3, the robot 4, and the like.

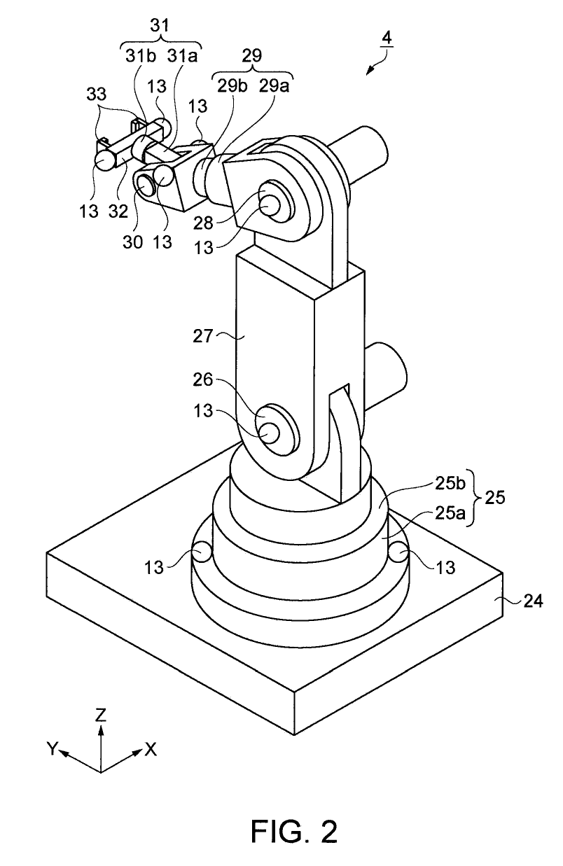

FIG. 2 is a perspective view schematically showing the robot. As shown in FIG. 2, the robot 4 includes a base 24. On the base 24, a rotation base 25 serving as a movable portion is provided. The rotation base 25 includes a fixed base 25a and a rotation axis 25b. The rotation base 25 includes a servomotor and a speed reduction mechanism therein, being able to rotate and stop the rotation axis 25b with angular accuracy. Provided on the fixed base 25a are the robot ultrasonic wave tags 13. By using the workpiece ultrasonic wave receiving device 16, locations of the workpiece ultrasonic wave tags 7 provided on the upper surfaces of the side plates 6 of the conveyor device 2 and locations of the robot ultrasonic wave tags 13 provided on the rotation base 25 are detected. Accordingly, it is possible to set data of a relative position between the conveyor device 2 and the robot 4. This allows the robot 4 to recognize a range in which the workpiece 11 flowing on the belt 9 can be captured.

A first joint 26 serving as a movable portion is provided in connection with the rotation axis 25b of the rotation base 25. A first arm 27 serving as a movable portion is provided in connection with the first joint 26. The robot ultrasonic wave tag 13 is provided on the rotation axis of the first joint 26. By detecting a position of this robot ultrasonic wave tag 13, a rotation angle when rotating the rotation axis 25b can be detected. A second joint 28 serving as a movable portion is provided in connection with the first arm 27. The robot ultrasonic wave tag 13 is provided on the rotation axis of the second joint 28. By detecting a position of this robot ultrasonic wave tag 13, a pose of the first arm 27 can be detected the first joint 26 as a center.

A second arm 29 serving as a movable portion is provided in connection with the second joint 28. The second arm 29 includes a fixed axis 29a and a rotation axis 29b. The second arm 29 can rotate the rotation axis 29b about a longitudinal direction of the second arm 29. A third joint 30 is provided in connection with the rotation axis 29b of the second arm 29. A pair of the robot ultrasonic wave tags 13 is provided on both ends of the third joint 30 in a rotation axis direction thereof. By detecting positions of these robot ultrasonic wave tags 13, a pose of the second arm 29 and a rotational state of the rotation axis 29b can be detected.

A third arm 31 serving as a movable portion is provided in connection with the third joint 30. The third arm 31 includes a fixed axis 31a and a rotation axis 31b. The third arm 31 can rotate the rotation axis 31b about a longitudinal direction of the third arm 31. A hand 32 serving as a movable portion is provided in connection with the rotation axis 31b of the third arm 31. The hand 32 is formed long in a direction orthogonal to the rotation axis 31b of the third arm 31. The robot ultrasonic wave tags 13 are provided on both ends in a longitudinal direction of the hand 32. By detecting positions of these robot ultrasonic wave tags 13, a pose of the hand 32 can be detected.

Provided to the hand 32 is a pair of fingers 33 serving as a movable portion. The hand 32 includes a servomotor and a linear moving mechanism driven by the servomotor. The linear moving mechanism can change an interval between the fingers 33.

The first joint 26, the second joint 28, the second arm 29, the third joint 30, and the third arm 31 respectively includes a servomotor and a speed reduction mechanism therein, so that they can rotate and stop the first, second, and third arms 27, 29, and 31 with angular accuracy. As described above, the robot 4 includes many joints and rotation mechanisms. In addition to the joints and the rotation mechanisms, controlling the fingers 33 enables the robot 4 to grip the workpiece 11.

The number of the robot ultrasonic wave tags 13 provided to the first arm 27, the second arm 29, the third arm 31, and the hand 32 is equal to or larger than the number of degrees of freedom that each portion can operate. Thus, it is possible to detect poses of each portion.

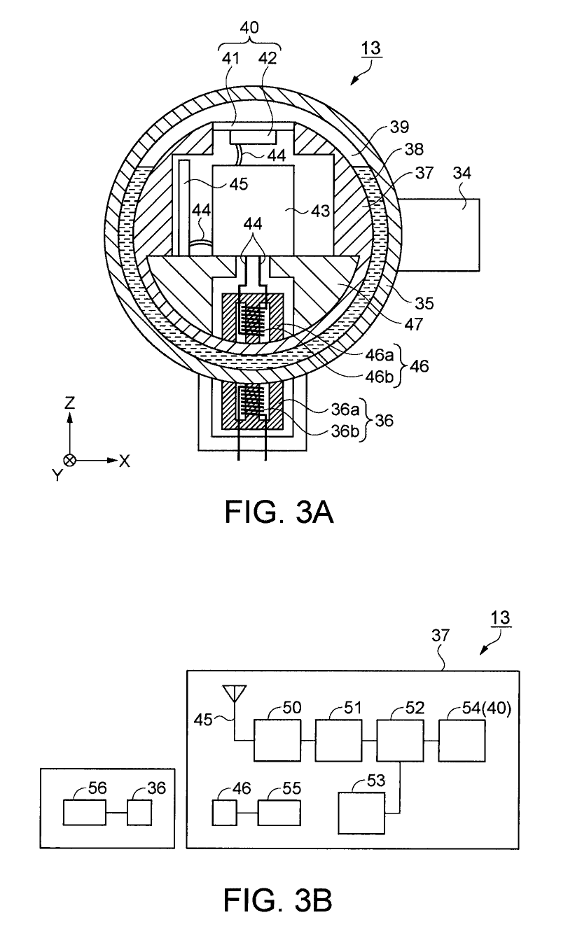

FIG. 3A is a sectional view schematically showing the robot ultrasonic wave tag. As shown in FIG. 3A, the robot ultrasonic wave tag 13 includes a support 34. Coupled to the support 34 is an exterior 35 having a sphere shape. The exterior 35 includes a cavity formed therein. The exterior 35 may be made of any material as long as ultrasonic waves can pass through the material. For example, the exterior 35 may be made of a hard resin or the like.

Provided below the exterior 35 is a power transmitting unit 36. The power transmitting unit 36 includes a core 36a, a coil 36b, and the like. The coil 36b is wound around the core 36a. By energizing an alternating current to the coil 36b, magnetic lines are formed in the core 36a. Then, it is possible to form a circuit of the formed magnetic lines toward the inside of the exterior 35.

Provided inside of the exterior 35 is a body 37 having a sphere shape. A space is formed between the body 37 and the exterior 35. The space includes a fluid 38 which is lubricious and a gas 39. Therefore, the body 37 easily moves within the exterior 35. The fluid 38 preferably is a material having low viscosity. In the present embodiment, a silicone oil is employed, for example.

Provided at the upper portion of the body 37 is an ultrasonic wave outputting unit 40. The ultrasonic wave outputting unit 40 includes a vibration plate 41, a piezoelectric element 42 fixed to the vibration plate 41, and the like. The piezoelectric element 42 is driven and the vibration plate 41 is vibrated, so that ultrasonic waves can be transmitted from the vibration plate 41.

The ultrasonic waves transmitted from the robot ultrasonic wave tag 13 spread in a cone and proceed. A spread angle and a frequency when the ultrasonic waves spread differ depending on the specification of the ultrasonic wave outputting unit 40. Thus, the spread angle and the frequency are not specifically limited. In the present embodiment, the spread angle is set to be about 100 degrees, for example. A frequency close to 40K Hz is employed for the frequency of the ultrasonic waves.

Provided below the ultrasonic wave outputting unit 40 is a circuit substrate 43. The piezoelectric element 42 and the circuit substrate 43 are electrically coupled with a wiring line 44. Provided to the left of the circuit substrate 43 in the drawing is an antenna 45. The antenna 45 and the circuit substrate 43 are electrically coupled with the wiring line 44.

Provided below the circuit substrate 43 is a power receiving unit 46. The power receiving unit 46 includes a core 46a, a coil 46b, and the like. The coil 46b is wound around the core 46a. When the power receiving unit 46 is opposed to the power transmitting unit 36, magnetic lines are outputted from the core 36a of the power transmitting unit 36. The outputted magnetic lines pass through the core 46a of the power receiving unit 46. Accordingly, a transformer is formed by the power transmitting unit 36 and the power receiving unit 46.

Provided at the lower portion of the body 37 is a plummet 47. The plummet 47 is made of a material whose specific gravity is greater than the body 37. Gravity acts on the plummet 47, thereby force in a gravity acceleration direction acts on the plummet 47. The body 37 is rotatably provided in the exterior 35. Therefore, regardless of the facing direction of the support 34 of the robot ultrasonic wave tag 13, the ultrasonic output unit 40 faces in the Z direction. Provided in the Z direction with respect to the robot 4 are robot ultrasonic wave receiving devices 19. As a result, each of the robot ultrasonic wave receiving devices 19 can receive the ultrasonic waves transmitted from the ultrasonic wave outputting unit 40.

FIG. 3B is a block diagram showing an electric control of the ultrasonic wave tag. As shown in FIG. 3B, the robot ultrasonic wave tag 13 includes the antenna 45. The antenna 45 is coupled to a receiving circuit 50. The receiving circuit 50 amplifies weak radio waves that the antenna 45 receives. Then, the antenna 45 and the receiving circuit 50 receive the radio signals transmitted from the radio wave transmitting device 8. The receiving circuit 50 is coupled to a code analyzing circuit 51. The code analyzing circuit 51 analyzes the radio signals transmitted from the radio wave transmitting device 8. Each of the radio signals includes a code signal and a transmission timing signal. The code analyzing circuit 51 analyzes the code signal so as to determine whether or not to transmit ultrasonic waves. A code of the code signal indicates an identification number. Each robot ultrasonic wave tag 13 has a code set in advance. The code analyzing circuit 51 determines whether or not the received code signal matches with the code set in the robot ultrasonic wave tag 13. When the received code signal matches with the code set in the robot ultrasonic wave tag 13, the code analyzing circuit 51 determines to transmit ultrasonic waves.

The code analyzing circuit 51 is coupled to a sending controlling circuit 52. The sending controlling circuit 52 is coupled to a transmission signal forming circuit 53 and a sending circuit 54. The transmission signal forming circuit 53 includes an oscillation circuit and forms voltage signals having a predetermined waveform. The waveform pattern is not specifically limited and a sine wave, a square wave, a triangle wave, or the like can be used. In the present embodiment, the sine wave is employed, for example. A frequency of the waveform is not limited to one kind. A plurality kinds of waveforms of a frequency may be formed. In a case where only one kind of waveform is used, the plurality kinds of waveforms of a frequency are not necessarily formed. The transmission signal forming circuit 53 outputs the formed voltage signals to the sending controlling circuit 52.

The sending controlling circuit 52 controls sending of signals. When the code analyzing circuit 51 determines to transmit ultrasonic waves, the transmission signal forming circuit 53 outputs the formed voltage signals to the sending circuit 54. Then, the transmission signal forming circuit 53 outputs the voltage signal in synchronization with the transmission timing signal. The sending circuit 54 includes an amplifier and the ultrasonic wave outputting unit 40. The amplifier amplifies the inputted voltage signals and outputs the voltage signals to the ultrasonic wave outputting unit 40. The ultrasonic wave outputting unit 40 includes the vibration plate 41 having the piezoelectric element 42 and the like, and vibrates the vibration plate 41 corresponding to the voltage signal. The vibration plate 41 vibrates the gas, allowing the ultrasonic wave outputting unit 40 to transmit ultrasonic waves.

The robot ultrasonic wave tag 13 includes a power supply unit 55. For the power supply unit 55, a battery, a secondary battery or the like can be used. In the present embodiment, a lithium secondary battery is employed for the power supply unit 55, for example. The power supply unit 55 supplies electric power to each circuit included in the robot ultrasonic wave tag 13.

The power supply unit 55 is electrically coupled to the power receiving unit 46. The power receiving unit 46 and the power transmitting unit 36 can form a transformer. The power transmitting unit 36 is electrically coupled to a main power supply unit 56. Electric power is supplied from the main power supply unit 56 to the power supply unit 55 through the power transmitting unit 36 and the power receiving unit 46.

The antenna 45, the receiving circuit 50, the code analyzing circuit 51, the sending controlling circuit 52, the transmission signal forming circuit 53, the sending circuit 54, the power supply unit 55, and the power receiving unit 46 are provided in the body 37. Then, the antenna 45 receives signals and electric power by air from the exterior of the body 37.

That is, the robot ultrasonic wave tag 13 receives radio signals. The robot ultrasonic wave tag 13 transmits ultrasonic waves when the identification code signal included in the radio signal matches with the identification code set in advance in the robot ultrasonic wave tag 13. At this time, the robot ultrasonic wave tag 13 transmits the ultrasonic wave in synchronization with the transmission timing signal included in the radio signal.

The workpiece ultrasonic wave tag 7 has the similar circuit structure as the robot ultrasonic wave tag 13. Therefore, the workpiece ultrasonic wave tag 7 has the similar functions as the robot ultrasonic wave tag 13. The workpiece ultrasonic wave tag 7 transmits ultrasonic waves when the identification code signal included in the radio signal matches with the identification code set in advance in the workpiece ultrasonic wave tag 7. At this time, the workpiece ultrasonic wave tag 7 transmits the ultrasonic wave in synchronization with the transmission timing signal included in the radio signal.

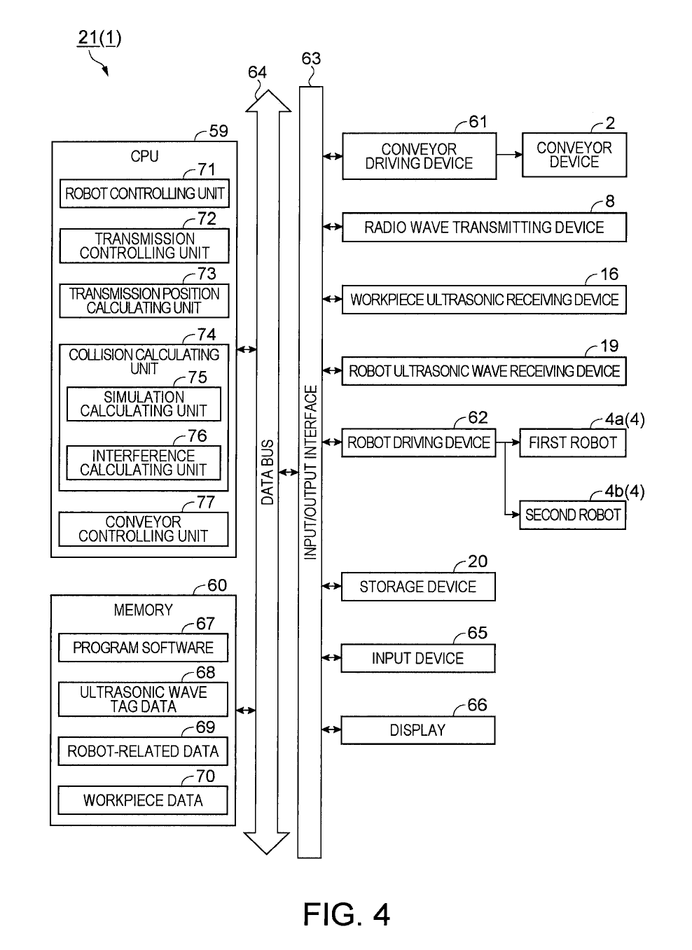

FIG. 4 is a block diagram showing an electric control of the robot system. Referring to FIG. 4, the control device 21 serving as a controller of the robot system 1 includes a central processing unit (CPU) 59 executing various calculation processes as a processor and a memory 60 serving as a storing unit storing various pieces of information.

A conveyor driving device 61, the radio wave transmitting device 8, the workpiece ultrasonic wave receiving device 16, the robot ultrasonic wave receiving device 19, a robot driving device 62, and the storage device 20 are coupled to the CPU 59 through an input/output interface 63 and a data bus 64. Further, an input device 65 and a display 66 are also coupled to the CPU 59 through the input/output interface 63 and the data bus 64.

The conveyor driving device 61 is coupled to the conveyor device 2 so as to control the conveyor device 2. The conveyor driving device 61 controls a movement and a stop of the belt 9 as well as a speed of the movement. The robot driving device 62 is coupled to the first and second robots 4a and 4b so as to control operations of the robot 4. The robot driving device 62 outputs information on pose of the robot 4 to the CPU 59. The robot 4 can move the hand 32 to a location specified by the CPU 59 and operate the finger 33.

The input device 65 inputs the code of the workpiece ultrasonic wave tag 7 and that of the robot ultrasonic wave tag 13 as well as behavior conditions such as a gripping method when the robot 4 grips the workpiece support 12. For example, the input device 65 receives coordinates indicating a shape of the workpiece support 12 of each workpiece 11 from an exterior device (not shown) and inputs the coordinates thereto. The display 66 displays data on the workpiece 11 and the robot ultrasonic wave tag 13 as well as operation states. Based on the information displayed on the display 66, operators perform input operations with the input device 65.

The memory 60 includes a semiconductor memory, such as RAMs and ROMs, and an external memory device, such as hard disks and DVD-ROMs. From a functional point of view, the memory 60 has a storage area storing program software 67 in which a controlling procedure of operations of the robot system 1 is described. In addition, the memory 60 has a storage area storing ultrasonic wave tag data 68 which is information such as the codes set in the workpiece ultrasonic wave tag 7 and the robot ultrasonic wave tag 13. In the ultrasonic wave tag data 68, a location where the robot ultrasonic wave tag 13 is provided and a relation with the codes of the robot ultrasonic wave tag 13 are stored. The memory 60 has a storage area storing robot-related data 69 which is information on a relative position between the conveyor device 2 and the robot 4, a relative position between the position detecting unit 3 and the robot 4, a relative position between the storage device 20 and the robot 4, and the like. The memory 60 has a storage area storing workpiece data 70 which is data on a shape of the workpiece 11, a location at which the fingers 33 of the robot 4 grip the workpiece 11, and the like. In addition, the memory 60 has a storage area serving as a work area or a temporary file for the CPU 59, and other various storage areas.

The CPU 59 performs identification of the workpiece 11 and control for moving the workpiece 11 in accordance with the program software 67 stored in the memory 60. As a specific function realization unit, the CUP 59 includes a robot controlling unit 71 performing control for moving the workpiece 11 by driving the robot 4. Further, the CPU 59 includes a transmission controlling unit 72 performing control of the radio wave transmitting device 8 so that specific workpiece ultrasonic wave tags 7 and the robot ultrasonic wave tags 13 transmit ultrasonic waves. The CPU 59 includes a transmission position calculating unit 73 serving as a position calculating unit calculating locations of the workpiece ultrasonic wave tag 7 and the robot ultrasonic wave tag 13 with the ultrasonic waves that the workpiece ultrasonic receiving device 16 and the robot ultrasonic wave receiving device 19 receive. The CPU 59 also includes a collision calculating unit 74 detecting a collision between the movable portion of the first robot 4a and the movable portion of the second robot 4b. The collision calculating unit 74 includes a simulation calculating unit 75 serving as a trajectory calculating unit, an interference calculating unit 76, and the like. The simulation calculating unit 75 simulates operations of the arms and the hand 32 of the robot 4. The interference calculating unit 76 calculates whether or not the movable portion of the first robot 4a interferences with the movable portion of the second robot 4b using the calculated result of the simulation. In addition, the CPU 59 includes a conveyor controlling unit 77 controlling operations of the belt 9 together with the operations of the robot 4, and the like.

Method for Controlling Robot

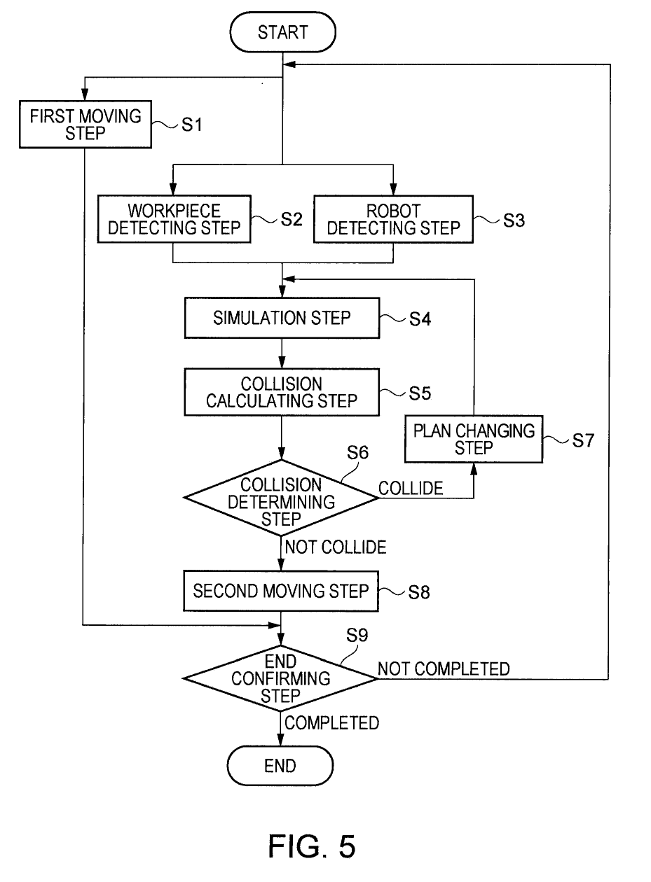

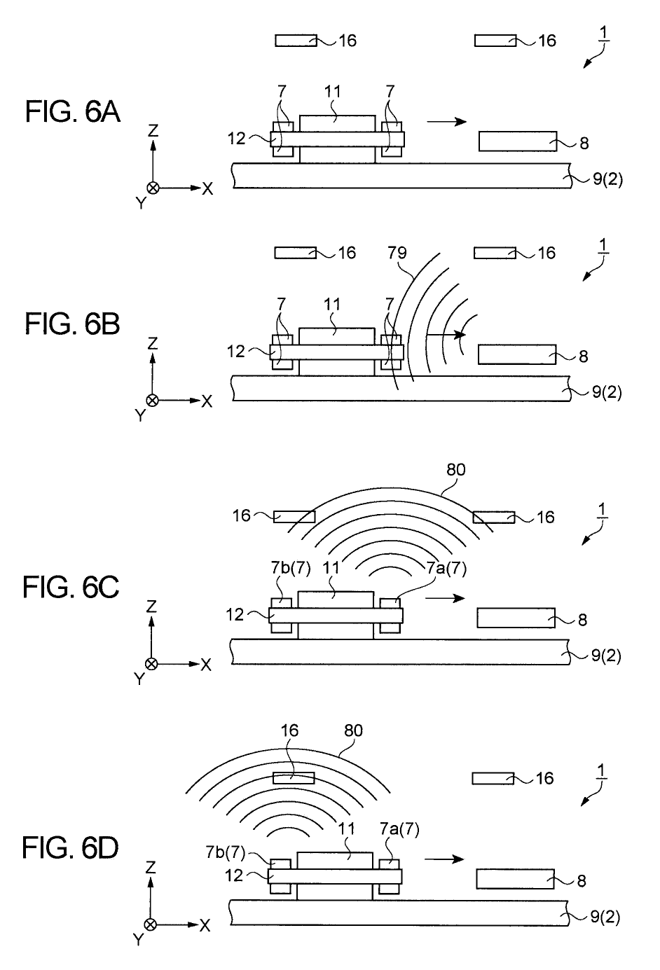

A method for controlling the robot will be described with reference to FIGS. 5 to 10C. In the method, the robot is controlled during an operation of moving the workpiece 11 from the conveyor device 2 to the storage device 20 by using the above-described robot system 1. FIG. 5 is a flowchart showing a process of moving the workpiece to the storage. FIGS. 6A to 10C are diagrams showing an operation method using the robot.

In the flowchart of FIG. 5, step S1 is simultaneously performed with steps S2 to S7. The step S1 corresponds to a first moving step. In the step, the workpiece is moved by the conveyor device. The step goes to step S9. The steps S2 and S3 are simultaneously performed. The step S2 corresponds to a workpiece detecting step. In the step, a location of the workpiece is detected by receiving the ultrasonic waves transmitted from the workpiece ultrasonic wave tag. The step goes to step S4. The step S3 corresponds to a robot detecting step. In the step, locations of each portion included in the robot are detected by receiving the ultrasonic waves transmitted from the robot ultrasonic wave tag. The step goes to the step S4. The step S4 corresponds to a simulation step. In the step, a location to which the workpiece moves is predicted, and a trajectory of the hand of the robot when moving the hand to the location is simulated. Additionally, a trajectory of the workpiece when moving the workpiece to the storage is simulated in the step. The step goes to step S5. The step S5 corresponds to a collision calculating step. In the step, it is calculated that whether or not the two robots collide with each using the simulation result of the trajectory of each movable portion of the robot. The step goes to step S6.

The step S6 corresponds to a collision determining step. In the step, it is determined that whether or not the two robots collide with each other. The step goes to step S7 in a case where portions of the robots collide with each other. The step goes to the step S8 in a case where no portions of the robots collide. The step S7 corresponds to a plan changing step. In the step, an operation plan of the robot is changed. The step goes to the step S4. The step S8 corresponds to a second moving step. In the step, the robot moves the workpiece to the storage device. The step goes to the step S9. The step S9 corresponds to an end confirming step. In the step, it is confirmed that whether or not all workpieces are flown. If there still is the workpiece to be flown and the operation is not completed, the step goes to the steps 1, 2, and 3. If there is no workpiece to be flown and the operation is completed, the process of moving the workpiece to the storage is completed.

The operation method using the robot corresponding to the steps shown in FIG. 5 will be described in detail with reference to FIGS. 6A to 10C. FIG. 6A corresponds to the first moving step of the step 1. As shown in FIG. 6A, the workpiece 11 is placed on the belt 9 in the step 1. The workpiece 11 is moved by the belt 9.

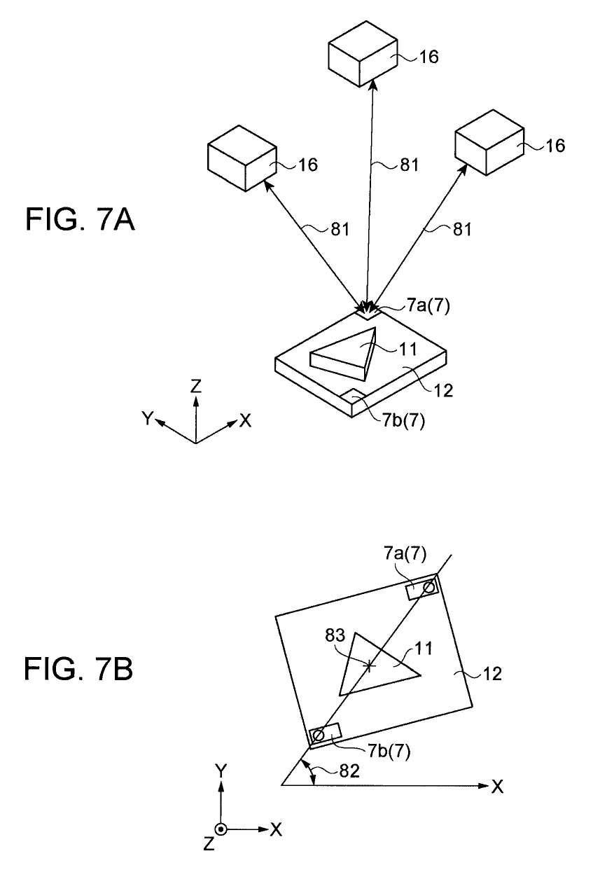

FIGS. 6B, 6C, 6D, 7A, and 7B correspond to the workpiece detecting step of the step S2. As shown in FIG. 6B, the radio wave transmitting device 8 outputs radio signals 79. A plurality kinds of the workpieces 11 is placed on the belt 9. The radio signals 79 are emitted toward the workpiece 11. The workpiece ultrasonic wave tag 7 has an identification code set therein. The radio signal 79 includes the identification code and the transmission timing signal used for transmitting ultrasonic waves. The radio wave transmitting device 8 switches the identification code and sequentially sends the radio signals 79. A pair of the workpiece ultrasonic wave tags 7 is provided on one side of the workpiece 11. The pair of the workpiece ultrasonic wave tags 7 is referred to as a first workpiece ultrasonic wave tag 7a and a second workpiece ultrasonic wave tag 7b. The workpiece ultrasonic wave tag 7 receives the radio signals 79.

As shown in FIG. 6C, the first workpiece ultrasonic wave tag 7a transmits ultrasonic wave signals 80 serving as a wireless signal and an ultrasonic wave when the identification code included in the radio signal 79 matches with the identification code set in the first workpiece ultrasonic wave tag 7a. The ultrasonic wave signals 80 transmitted in the Z direction from the first workpiece ultrasonic wave tag 7a are received by three of the workpiece ultrasonic wave receiving devices 16. The transmission controlling unit 72 detects the time elapsed between the transmission of the ultrasonic wave signal 80 from the first workpiece ultrasonic wave tag 7a and the reception of the ultrasonic wave signal 80 at each workpiece ultrasonic wave receiving device 16. Then, the transmission controlling unit 72 stores the time elapsed in the memory 60.

The time elapsed is detected by detecting amplitude of the ultrasonic wave signal 80, detecting timing that a waveform of the ultrasonic wave signal 80 corresponds to a waveform of a reference wave by comparing with each other, a phase matching method in which the ultrasonic wave signal 80 having two kinds of frequencies is transmitted so as to detect a phase of the received ultrasonic wave signal 80, and the like. Since the phase matching method is disclosed in JP-A-2006-242640, the specific description thereof will be omitted. The phase matching method has high measurement accuracy. Thus, with this method, the time elapsed between the transmittance of the ultrasonic wave signal 80 and the reception of the ultrasonic wave signal 80 can be measure with high accuracy. Here, any of the known methods can be used as a detection method. In the present embodiment, the phase matching method is employed, for example.

The radio signals 79 are sequentially sent from the radio wave transmitting device 8 to the workpiece ultrasonic wave tag 7. As shown in FIG. 6D, the second workpiece ultrasonic wave tag 7b transmits the ultrasonic wave signals 80 when the identification code included in the radio signal 79 matches with the identification code set in the second workpiece ultrasonic wave tag 7b. The ultrasonic wave signals 80 are received by three of the workpiece ultrasonic receiving devices 16. The transmission controlling unit 72 detects the time elapsed between the transmission of the ultrasonic wave signal 80 from the second workpiece ultrasonic wave tag 7b and the reception of the ultrasonic wave signals at each workpiece ultrasonic wave receiving device 16. Then, the transmission controlling unit 72 stores the time elapsed in the memory 60.

As shown in FIG. 7A, three of the workpiece ultrasonic wave receiving devices 16 receive the ultrasonic wave signal 80 transmitted from the first workpiece ultrasonic wave tag 7a. The transmission position calculating unit 73 adds the time elapsed between the transmission of the ultrasonic wave signal 80 from the first workpiece ultrasonic wave tag 71 and the reception of the ultrasonic wave signal 80 at each workpiece ultrasonic wave receiving device 16 to the rate of travel of the ultrasonic wave signal 80 so as to calculate distances 81 that are distances between the first workpiece ultrasonic wave tag 7a and each workpiece ultrasonic wave receiving device 16.

Locations of the workpiece ultrasonic wave receiving devices 16 in the robot system 1 are measured in advance, and coordinates of the workpiece ultrasonic receiving devices 16 are stored in the robot-related data 69. The transmission position calculating unit 73 calculates a location of the first workpiece ultrasonic wave tag 7a in the robot system 1 by a triangulation method. Subsequently, the transmission position calculating unit 73 calculates a location of the second workpiece ultrasonic wave tag 7b by the same method.

As shown in FIG. 7B, a pose of the workpiece 11 is computed. The pose of the workpiece 11 shows a pose angle 82 with respect to a moving direction of the workpiece 11. In the present embodiment, the moving direction of the workpiece 11 is the X direction. An angle formed by a straight line passing through the first and second workpiece ultrasonic wave tags 7a and 7b and the X direction is referred to as the pose angle 82. The midpoint between the first and second workpiece ultrasonic wave tags 7a and 7b is computed. This midpoint is referred to as a workpiece position 83. The workpiece position 83 and the pose angle 82 are stored in the memory 60 as the workpiece data 70.

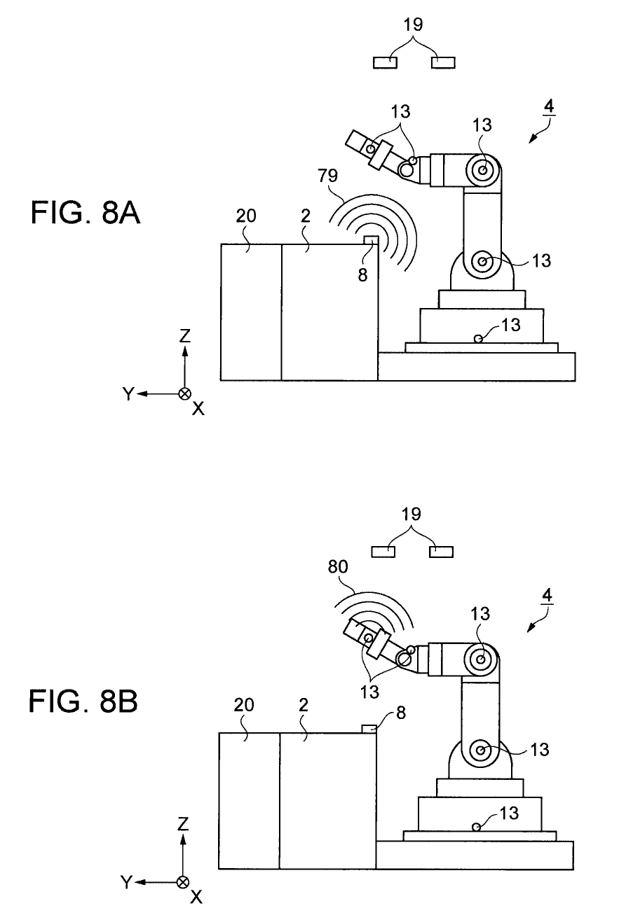

FIGS. 8A and 8B are diagrams corresponding to the robot detecting step of the step S3. As shown in FIG. 8A, the radio wave transmitting device 8 emits the radio signals 79 toward the robot 4. The robot ultrasonic wave tag 13 has an identification code set therein in the same manner as the workpiece ultrasonic wave tag 7. The radio signal 79 includes the identification code and the transmission timing signal used for transmitting ultrasonic waves. The radio wave transmitting device 8 switches the identification code and sequentially sends the radio signals 79. The robot ultrasonic wave tag 13 receives the radio signals 79.

As shown in FIG. 8B, the robot ultrasonic wave tag 13 transmits the ultrasonic wave signals 80 when the identification code included in the radio signal 79 matches with the identification code set in the robot ultrasonic wave tag 13. The robot ultrasonic wave tag 13 transmits the ultrasonic wave signals 80 in the Z direction. Then, the ultrasonic wave signals 80 are received by the robot ultrasonic wave receiving devices 19. The transmission controlling unit 72 detects the time elapsed between the transmission of the ultrasonic wave signal 80 from the robot ultrasonic wave tag 13 and the reception of the ultrasonic wave signal 80 at each robot ultrasonic wave tag 19. Then, the transmission controlling unit 72 stores the time elapsed in the memory 60.

In the same manner as the step S2, the ultrasonic wave signals 80 transmitted from the robot ultrasonic wave tag 13 are received by three of the robot ultrasonic wave receiving devices 19. Then, the transmission position calculating unit 73 calculates the distances 81 which are distances between the robot ultrasonic wave tag 13 and each robot ultrasonic wave receiving device 19. The transmission position calculating unit 73 calculates a location of the robot ultrasonic wave tag 13 by the triangulation method. The transmission position calculating unit 73 stores the locational information on the position of the robot ultrasonic wave tag 13 in the memory 60 as the ultrasonic wave tag data 68.

The radio wave transmitting device 8 makes the robot ultrasonic wave tags 13 provided to the robot 4 sequentially transmit the ultrasonic wave signals 80. After the robot ultrasonic wave receiving device 19 receives the ultrasonic wave signals 80, the transmission position calculating unit 73 calculates the location of the robot ultrasonic wave tag 13. The transmission position calculating unit 73 calculates positions and poses of each movable portion of the robot 4 using the locational information on the robot ultrasonic wave tags 13. The transmission position calculating unit 73 stores the locations of each robot ultrasonic wave tag 13 in the memory 60 as well as the positions and the poses of each movable portion.

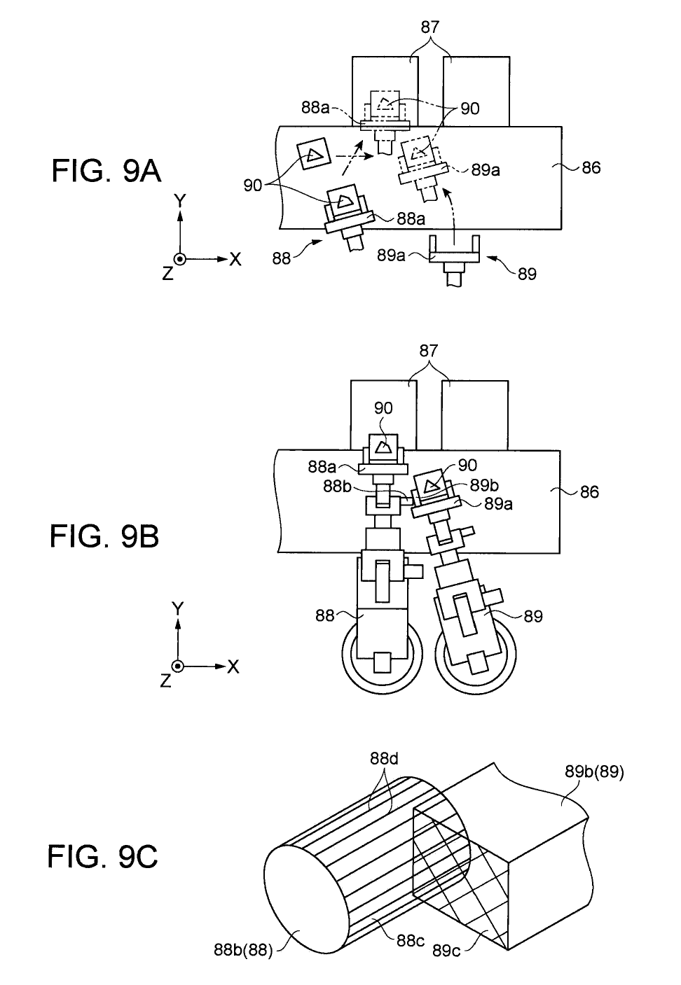

FIG. 9A is a diagram corresponding to the simulation step of the step 4. An example of simulating operations of the workpiece 11 and the robot 4 is given. As shown in FIG. 9A, a location to which the workpiece 11 to be moved is presumed in the step S4. The belt 9 of the conveyor device 2 moves at a uniform velocity. The location of the workpiece 11 at a given time is detected, so that it is presumed that the workpiece 11 is moved in a moving direction of the belt after a predetermined time. The simulation calculating unit 75 provides models, such as a belt 86, a storage device 87, a first robot 88, a second robot 89, and a workpiece 90, in a virtual space. The belt 86 corresponds to the belt 9 of the conveyor device 2 while the storage device 87 corresponds to the storage device 20. The robot 88 corresponds to the first robot 4a while the second robot 89 corresponds to the second robot 4b. The workpiece 90 corresponds to the workpiece 11. Each model is set to have the same size and shape as those of the actual portions.

The simulation calculating unit 75 calculates a trajectory of the workpiece 90 moving along with a movement of the belt 86. Next, the simulation calculating unit 75 calculates an operation of the second robot 89. The second robot 89 includes a hand 89a. The hand 89a corresponds to the hand 32. The simulation calculating unit 75 calculates a trajectory of the hand 89a of the second robot 89 moving to the location to which the workpiece 90 to be moved. Then, the simulation calculating unit 75 determines a location at which the hand 89a of the second robot 89 grips the workpiece 90.

The simulation calculating unit 75 calculates an operation of the first robot 88. The first robot 88 simultaneously operates with the second robot 89. The first robot 88 includes a hand 88a. The hand 88a corresponds to the hand 32. The hand 88a of the first robot 88 moves the workpiece 90 to the storage device 87 while gripping the workpiece 90. The simulation calculating unit 75 calculates a trajectory of the movement of the first robot 88.

FIGS. 9B and 9C are diagrams corresponding to the collision calculating step of the step S5. As shown in FIG. 9B, in the step 5, the interference calculating unit 76 calculates the operations of the first and second robots 88 and 89. The interference calculating unit 76 uses the calculated presumed data of the trajectories. The interference calculating unit 70 performs a calculation so that the first and second robots 88 and 89 are simultaneously operated. The interference calculating unit 70 selects portions of the first and second robots 88 and 89 that come close to each other.

The first robot 88 includes a motor 88b. The motor 88b corresponds to a motor (not shown) included in the third joint 30. The second robot 89 includes fingers 89b. The fingers 89b correspond to the fingers 33. For example, a case is described in which the motor 88b of the first robot 88 and the fingers 89b of the second robot 89 come close to each other.

It is calculated that whether or not the portions come close interfere with each other. As shown in FIG. 9C, a side surface of the fingers 89b of the second robot 89 and that is adjacent to the first robot 88 is referred to as a finger side surface 89c. It is calculated that whether or not the finger side surface 89c interferes with the motor 88b. A formula of the finger side surface 89c is calculated by a location and a pose of the fingers 89b. Since the finger side surface 89c is a flat surface, the formula of the finger side surface 89c can be shown as aX+bY+cZ+d=0 when a, b, c, and d are coefficients. The formula of the finger side surface 89c can be calculated by computing the coefficients using points on the finger side surface 89c.

A side surface of the motor 88b is referred to as a motor side surface 88c. The motor 88b has a cylindrical shape. Then, segments 88d on the motor side surface 88c in an axial direction of the motor 88b are set. The segments 88d are set by divining the motor side surface 88c into several portions in a periphery direction. Though it is preferable that the segments 88d are provided with equal intervals, it is not necessarily limited. An area of the motor side surface 88c to be examined in detail may be finely divided.

Subsequently, it is calculated that whether or not each segment 88d passes through the finger side surface 89c. First, a formula of the segments 88d is calculated. The formula of the segments 88d, which passes through coordinates (x, y, z) and whose directional vector is (l, m, n), can be shown as (X−x)/1=(Y−y)/m=(Z−z)/n. The formula of the segments 88d can be calculated by computing the coefficients using the points on the segments 88d.

Coordinates of an intersection, which is a point at the intersection of the segments 88d with the finger side surface 89c, are calculated from the formula of the segments 88d and that of the finger side surface 89c. Subsequently, it is calculated that whether or not the intersection is a range within the finger side surface 89c and the motor side surface 88c. It is determined that the fingers 89b and the motor 88b interfere with each other when the intersection is within both surfaces of the finger side surface 89c and the motor side surface 88c. The portions that interfere with each other and the time of the interference are stored in the memory 60 as the robot-related data 69.

In the collision determining step of the step S6, it is confirmed that whether or not there is a location at which the first robot 88 and the second robot 89 interfere with each other using the robot-related data 69. If there is such location, a plan to drive the first and second robots 88 and 89 is changed in the plan changing step of the step 7.

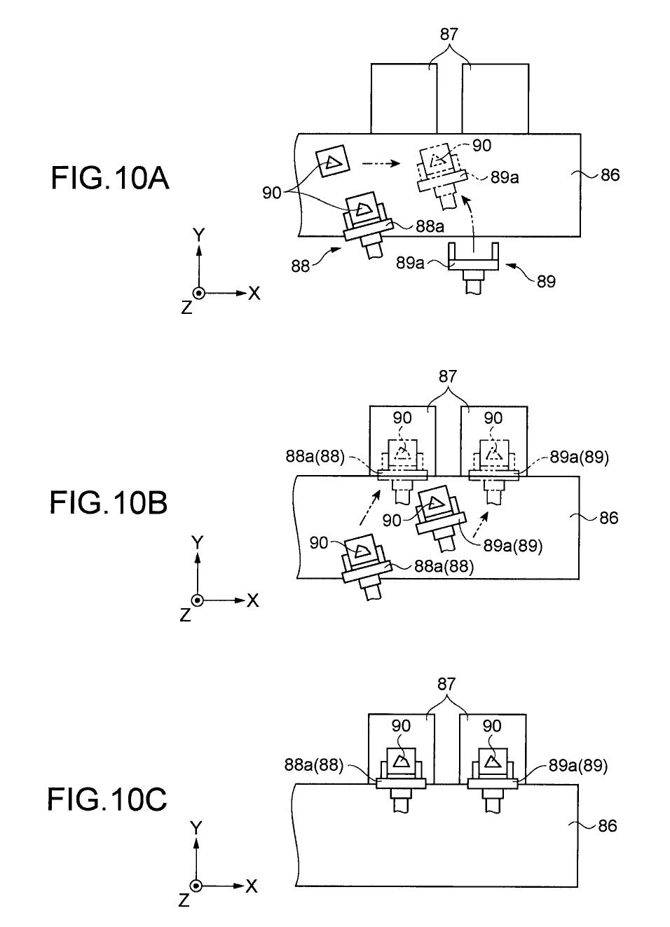

FIGS. 10A, 10B, and 10C are diagrams corresponding to the plan changing step of the step S7. As shown in FIG. 10A, the plan to drive the first and second robots 88 and 89 is changed in the step S7. The first robot 88 grips the workpiece 90. The workpiece 90 moves along with the movement of the belt 86, and the hand 89a of the second robot 89 moves to the workpiece 90. These operations do not change. The first robot 88 stops during the movement of the second robot 89. Therefore, a plan that the first robot 88 moves the hand 88a to the storage device 87 is changed.

As shown in FIG. 10B, the second robot 89 grips the workpiece 90. The first robot 88 moves the hand 88a toward the storage device 87 and the second robot 89 moves the hand 89a toward the storage device 87. At this time, the first and second robots 88 and 89 move substantially parallel with each other, so that they hardly collide. As a result, as shown in FIG. 10 C, the first and second robots 88 and 89 respectively move the workpieces 90 to locations facing the storage device 87. The plan to drive the robot 4 is changed as above.

Subsequently, the simulation step of the step S4 and the collision calculating step of the step S5 are performed based on the changed plan. After it is confirmed in the collision determining step of the step S6 that the first and second robots 88 and 89 do not collide with each other, the second moving step of the step S8 is performed. In the step S8, the robot 4 is driven as planned in the plan changing step of the step S7 so as to move the workpiece 11 to the storage device 20. As described above, the process of moving the workpiece 11 from the conveyor device 2 to the storage device 20 is completed.

According to the embodiment described above, the following advantageous effects are provided. According to the embodiment, the robot ultrasonic wave tags 3 are provided to the hand 32, the third joint 30, and the like of the robot 4. By detecting locations of the robot ultrasonic wave tags 13, a pose of the robot 4 can be detected. The pose of the robot 4 is detected by proving a sensor, such as an encoder, to a portion where the movable portions are coupled to each other. Then, a relative position between the movable portions is detected. In that case, positional data of one end of each movable portion is added to positional data of another end of each movable portion, so that it is possible to compute relative positional data of both ends of the movable portion to be coupled. Compared with this method, the locations of the robot ultrasonic wave tags 13 are directly detected in the embodiment. As a result, the transmission position calculating unit 73 can detect positions and poses of the hand 32, the third joint 30, and the like in a short period of time.

According to the embodiment, distances between the robot ultrasonic wave tags 13 and the robot ultrasonic wave receiving devices 19 are measured with the ultrasonic wave signals 80. Compared with a propagation velocity of electromagnetic waves such as light and radio waves, a propagation velocity of ultrasonic waves is slower. Therefore, the speed of the ultrasonic waves is faster than that of the electromagnetic waves. As a result, arrival time of the ultrasonic waves can be easily measured compared with the case of using the electromagnetic waves.

According to the embodiment, the robot ultrasonic wave tags 13 are provided to the first arm 27, the second arm 29, and the like corresponding to the number of degrees of freedom at the movable portion. As a result, a location to which the movable portion moves and a pose of the movable position can be detected.

According to the embodiment, a pose of the movable portion, such as the hand 32, is recognized using locational information of the robot ultrasonic wave tags 13. Then, a calculation is performed for simulating a transition of the movable portion from the pose. The transition of the movable portion is computed based on the position of the movable portion before the transition. As a result, the transition of the movable portion can be accurately computed.

According to the embodiment, a position of the robot ultrasonic wave tag 13 can be detected in a short period of time. The interference calculating unit 76 detects a collision between the robots using data on the robot ultrasonic wave tag 13. As a result, the collision between the robots can be detected in a short period of time.

According to the embodiment, the simulation calculating unit 75 performs a calculation for simulating the transition of the movable portion. Then, the interference calculating unit 76 calculates interference between the movable portions. As a result, it is possible to detect a collision between the movable portions at each location during the movement of the movable portions.

According to the embodiment, the robot ultrasonic wave tag 13 transmits the ultrasonic wave signals 80 in the Z direction regardless of a pose of the robot 4. As a result, the robot ultrasonic wave tag 3 can transmit the ultrasonic wave signals 80 toward the robot ultrasonic wave receiving device 19 regardless of poses of the movable portions of the robot 4.

According to the embodiment, the transmission position calculating unit 73 calculates a relative position between the conveyor device 2 and the robot 4. As a result, the robot 4 can recognize a reachable range of the movable portions of the robot with respect to the conveyor device.

Here, the embodiment is not limited to the above-described and various changes and modification can be made. Modifications will now be described.

First Modification

In the embodiment above, ultrasonic waves are used for measuring a distance between the robot ultrasonic wave tag 13 and the robot ultrasonic wave receiving device 19. In stead of the ultrasonic waves, waveforms from other media may be used. For example, the distance may be measured by detecting a phase of light using laser light or infrared light. Electromagnetic waves may be used for measuring the distance. The easiest method for measuring the distance may be employed. In this case, locations and poses of each movable portion of the robot 4 can be detected as well.

Second Modification

In the embodiment above, the workpiece 11 is moved to the storage device 20 together with the workpiece support 12. The workpiece support 12 may be left on the belt 9 so that only the workpiece 11 is moved to the storage device 20. A detachment mechanism may be provided to the workpiece support 12. In that case, the detachment mechanism may be operated by the hand 32. This enables operations in the following step to be easily performed.

Third Modification

In the embodiment above, the radio wave transmitting device 8 sends radio signals to the robot ultrasonic wave tag 13. The radio wave transmitting device 8 may be replaced with an optic communications device, and the optic communications device may perform optical communication with the robot ultrasonic wave tag 13. This makes it possible to reduce the effect of electromagnetic noise.

Fourth Modification

In the embodiment above, a location of the robot ultrasonic wave tag 13 is calculated by the ultrasonic wave signals 80 received by three of the robot ultrasonic wave receiving devices 19. Four of the robot ultrasonic wave receiving devices 19 may be provided to the single robot 4. Then, the location of the robot ultrasonic wave tag 13 may be calculated by the ultrasonic wave signals 80 received by the four robot ultrasonic wave receiving devices 19. A method for calculating a location of an ultrasonic wave source is disclosed in JP-A-6-222130. In the method, one of the ultrasonic wave source and four ultrasonic sonic wave receiving devices are used. Four equations are formed according to distances between the ultrasonic wave source and the four ultrasonic wave receiving devices. The location of the ultrasonic wave source is computed by obtaining solutions to the equations. This method may be employed for computing the location of the robot ultrasonic wave tag 13. Since this method may not require the transmission timing signals that the radio wave transmitting device 8 transmit, a structure of the circuit can be simplified.

Fifth Modification

In the embodiment above, the radio wave transmitting device 8 sequentially switches the identification code and sends the radio signals 79 in the robot detecting process of the step S3. After receiving the radio signals 79, the robot ultrasonic wave tag 13 transmits the ultrasonic wave signals 80. The procedure may not be limited to this. After a lapse of predetermined time from the transmission of the ultrasonic wave signals 80 from one of the robot ultrasonic wave tags 13, the ultrasonic wave signals 80 may be sequentially transmitted from the rest of the robot ultrasonic wave tags 13. Since the procedure is simplified, the program software 67 can be simplified as well. As a result, the program software 67 can be manufactured with high efficiency.

Sixth Modification

In the embodiment above, the workpiece 11 is moved by the conveyor device 2. However, the method of moving the workpiece 11 is not limited to this. It is only required that the workpiece 11 can move along a predetermined course. For example, a self-propelled device may be provided to the workpiece support 12. This enables the workpiece 11 to be easily moved between the steps.

Seventh Modification

Though in the embodiment above, the workpiece 11 is moved straight ahead by the belt 9 of the conveyor device 2, it is not limited to this. The workpiece 11 may be moved in a curve by the belt 9. Further, the workpiece 11 may turn at a predetermined angle and proceed. Also in this case, when a trajectory of the movement of the workpiece 11 is presumed in advance, the simulation calculating unit 75 can simulate operations of the workpiece 11 and the robot 4.

Eighth Modification

In the embodiment above, the robot 4 grips the workpiece 11 while the workpiece 11 is moved by the belt 9 in the second moving step of the step S8. However, the belt 9 may be stopped when the robot 4 grips the workpiece 11. This enables the robot 4 to easily grip the workpiece 11.

Ninth Modification

In the embodiment above, the robot ultrasonic wave tag 13 transmits the ultrasonic wave signals 80. A frequency transmitted from the ultrasonic wave signal 80 may be varied with respect to each robot ultrasonic wave tag 13. For example, a frequency analyzing circuit is added to the robot ultrasonic wave receiving device 19. Then, the robot ultrasonic wave receiving device 19 analyzes the frequency of the ultrasonic wave signal 80. Accordingly, the robot ultrasonic wave receiving device 19 can recognize the robot ultrasonic wave tag 13 from which the ultrasonic wave signals 80 are transmitted.

Tenth Modification

In the embodiment above, the transmission position calculating unit 73 calculates positions and poses of each movable portion of the robot 4 using locational information on the robot ultrasonic wave tags 13. The transmission position calculating unit 73 may calculate movement trajectories of each movable portion. The transmission position calculating unit 73 stores locations of the robot ultrasonic wave tags 13 in the memory 60. The transmission position calculating unit 73 regenerates the past locational data of the robot ultrasonic wave tags 13 stored in the memory 60. The transmission position calculating unit 73 calculates the movement trajectories of each movable portion with the data. The transmission position calculating unit 73 may simulate operations of each movable portion in view of inertia force applied to each movable portion from the information on the trajectories of each movable portion. As a result, each movable portion can be simulated with high accuracy.

Eleventh Modification

In the embodiment above, the transmission position calculating unit 73 calculates positions and poses of each movable portion of the robot 4 using locational information on the robot ultrasonic wave tags 13. The transmission position calculating unit 73 may detect vibrations of each movable portion by operations of the robot ultrasonic wave tag 13. When the movable portion of the robot 4 vibrates unwantedly, instructions for maintaining the robot 4 may be displayed in the display 66. Accordingly, is it possible to know the appropriate maintenance time of the robot 4. By maintaining the robot 4, the robot 4 can be operated with high quality.

Twelfth Modification

In the embodiment above, the workpiece ultrasonic wave receiving device 16 is provided to the first receiving device support 15 while the robot ultrasonic wave receiving device 16 is provided to the second receiving device support 18. The workpiece ultrasonic receiving device 16 may not be directly coupled to the conveyor device 2. The robot ultrasonic wave receiving device 19 may be coupled to the second receiving device support 18 with no member having rigidity interposed therebetween. The workpiece ultrasonic receiving device 16 and the robot ultrasonic wave receiving device 19 may be installed on the ceiling of the room where the robot system 1 is provided. The transmission position calculating unit 73 may detect a location of the conveyor device 2 and a location of the robot 4 so as to recognize a relative position between the conveyor device 2 and the robot 4. Also in this case, the relative position between the conveyor device 2 and the robot 4 can be recognized with high accuracy. Since the first and second receiving device supports 15 and 16 can be omitted, this allows the robot system 1 to be a resource saving system.

The entire disclosure of Japanese Patent Application No. 2008-288533 filed Nov. 11, 2008 is expressly incorporated by reference herein.

What is claimed is:

1. A robot system, comprising:
a robot including a movable portion;
a plurality of transmitters that is provided on the movable portion and transmits wireless signals;
three or more receivers receiving the wireless signals transmitted from each of the transmitters; and
a position calculating unit detecting locations of the transmitters based on the wireless signals that the plurality of the receivers receives, wherein the position calculating unit detects a pose of the robot from information on the locations of the detected plurality of the transmitters.

2. The robot system according to claim 1, further comprising a conveyor conveying a workpiece and a plurality of transmitters provided on the conveyor, wherein the position calculating unit detects a location of the conveyor with the receivers so as to calculate a relative position between the conveyor and the robot.

3. The robot system according to claim 2, wherein the position calculating unit calculates a trajectory of the movable portion.

4. The robot system according to claim 3, wherein the transmitter is an ultrasonic wave tag transmitting an ultrasonic wave while each of the receivers receives the ultrasonic wave.

5. The robot system according to claim 4, wherein the number of transmitters provided on the movable portion is equal to or larger than the number of degrees of freedom at the movable portion.

6. The robot system according to claim 5, further comprising a simulation calculating unit calculating a transition of the trajectory of the movement of the movable portion, wherein the simulation calculating unit calculates the transition of the trajectory of the movement using the information on the locations of the transmitters.

7. A robot system, comprising:
a plurality of robots operating in the robot system;
a plurality of transmitters that is provided on a movable portion of each of the robots and transmits wireless signals;
three or more receivers receiving the wireless signals transmitted from each of the transmitters;
a position calculating unit detecting locations of the transmitters based on the wireless signals that the plurality of the receivers receives; and
a collision calculating unit presuming whether or not the robots collide with each other, wherein the collision calculating unit detects a collision between the robots using information on the locations of the transmitters.

8. The robot system according to claim 7, wherein each of the transmitters is an ultrasonic wave tag transmitting an ultrasonic wave while each of the receivers receives the ultrasonic wave.

9. The robot system according to claim 8, wherein the collision calculating unit includes a simulation calculating unit calculating a transition of a trajectory of a movement of the movable portion and an interference calculating unit calculating whether or not the movable portion of each of the robot interfere with each other.
